(19) United States
(12) Patent Application Publication
(10) Pub. No.: US 2012/0258312 A1
(43) Pub. Date: Oct. 11, 2012

(54) WEATHER-RESISTANT HARD COATING COMPOSITION AND COATED ARTICLE

(76) Inventor: Koichi HIGUCHI, Annaka-shi (JP)

(21) Appl. No.: 13/433,547

(22) Filed: Mar. 29, 2012

(30) Foreign Application Priority Data
Apr. 7, 2011 (JP) 2011-085068

(51) Int. Cl. B32B 9/04; C08K 3/22; C09D 183/06

(52) U.S. Cl. 428/412; 524/506; 524/413; 524/432; 524/403; 428/447

(57) ABSTRACT

A weather-resistant hard coating composition to be used for direct coating on at least one surface of an organic resin substrate, the composition containing the following components.
(1) A silicone resin resulting from (co)hydrolysis and condensation of at least one selected from those alkoxysilanes represented by the following formulas (1-1), (1-2), and (1-3) or condensates of their partial hydrolyzates,

(R¹)ₘ(R²)ₙSi(OR³)₄₋ₘ₋ₙ (1-1)

(R⁴O)₃₋ₚ(R⁶)ₚSi—R⁸—Si(R⁷)_{q}(OR⁵)_{3-q} (1-2)

X—[(R¹⁵)Si(R¹⁶)_{y}(OR¹⁷)_{3-y}]_{z} (1-3)
(2) A vinyl copolymer having in its side chain an organic ultraviolet-absorbing group and a reactive group selected from an alkoxysilyl group, hydroxyl group, epoxy group, carboxylic acid group, and amino group,
(3) A curing catalyst, and
(4) A solvent.

The silicone resin as component (1) and the vinyl copolymer as component (2) exist in such amounts in terms of solids that the ratio of (1)/(2) is from 10/90 to 50/50 by weight.

### CROSS-REFERENCE TO RELATED APPLICATION

This non-provisional application claims priority under 35U.S.C. §119(a) on Patent Application No. 2011-085068 filed in Japan on Apr. 7, 2011, the entire contents of which are hereby incorporated by reference.

### TECHNICAL FIELD

The present invention relates to a composition for weather-resistant hard coating to be used for direct coating on at least one surface of an organic resin substrate, the composition being composed of (1) a specific silicone resin, (2) a specific vinyl copolymer, (3) a curing catalyst, and (4) a solvent. The present invention relates also to a coated article with hard coating which is made up of an organic resin substrate and a layer of hard coating formed thereon from the composition by curing.

### BACKGROUND ART

There has recently been a general tendency toward the substitution of clear sheet glass with a transparent material which is unbreakable or harder to break than sheet glass. Typical examples of such substitutes are plastics, especially polycarbonate resin, which currently finds various uses as construction members such as window panes for buildings and vehicles and instrument covering in place of glass on account of its outstanding clarity, impact resistance, and heat resistance.

Unfortunately, the polycarbonate resin is inferior to glass in surface properties, such as scratch resistance and weather resistance, and this has aroused a demand for improvement of its molded articles in surface properties. The recent requirement for polycarbonate resin used as window panes and road sound barriers is durability at least ten years in outdoor exposure.

There have been proposed several means for improving the weather resistance of molded products of polycarbonate resin; one of them is by lamination with a highly weather-resistant acrylic resin film on the surface of polycarbonate resin substrate, and the other is by coextrusion to form a resin layer containing a UV absorber on the surface of polycarbonate resin substrate.

One way proposed so far to improve the scratch resistance of molded products of polycarbonate resin is by coating with a thermosetting resin such as polyorganosiloxane and melamine, or by coating with a photocurable resin such as polyfunctional acrylic resin.

On the other hand, there is known a transparent body having both weather resistance and scratch resistance, which is produced by the process disclosed in JP-A S56-92059 and JP-A H01-149878. It is an ultraviolet-absorbing clear board coated with a protective film of polysiloxane coating layer containing colloidal silica, with an undercoating layer interposed thereunder which is incorporated with a large amount of ultraviolet-absorbing agent.

The foregoing product, however, suffers the disadvantage resulting from incorporation of a large amount ultraviolet-absorbing agent into the undercoating layer. In other words, the ultraviolet-absorbing agent makes the undercoating layer poor in adhesion to the substrate thereunder and the protective film thereon of polysiloxane coating material containing colloidal silica. Moreover, it vaporizes during heating and curing and disappears from the compound, and it gradually bleeds out during outdoor use for a long period of time, resulting in cracking and whitening or yellowing. Another disadvantage is that the protective coating film layer of polysiloxane containing colloidal silica cannot accept a large amount of ultraviolet-absorbing agent if it is to have good scratch resistance.

There is also known a protective film to be applied to a plastics substrate, as disclosed in JP-A H08-151415. This protective film is formed from a mixture composed of two vinyl monomers copolymerizable with each other, one of them containing a benzotriazole- or benzophenone-based ultraviolet-absorbing agent. Unfortunately, this protective film is limited in scratch resistance because it is formed from a vinyl polymer.

There is also known a multilayered plastics article which has good adhesion to the plastics substrate as well as good weather resistance. It is formed from a coating compound composed of a vinyl monomer containing a benzotriazole- or benzophenone-based ultraviolet-absorbing agent, a vinyl monomer containing alkoxysilyl groups, and a vinyl monomer copolymerizable therewith. See JP-A 2001-114841, Japanese Patent No. 3102696, JP-A 2001-214122, JP-A 2001-47574, JP-A 2008-120986, and JP-A 2008-274177.

The foregoing copolymer-based coating material is made into an undercoating layer on which is formed a coating film of polysiloxane resin containing colloidal silica, so that there is obtained a coated article having scratch resistance and weather resistance. The thus obtained coated article has improved adhesion to the polysiloxane resin coating film and weather resistance. However, the coated article is subject to cracking and peeling and unsatisfactory in long-term weather resistance because the undercoating layer contains alkoxysilyl groups which do not form the crosslinked network completely, leaving uncured alkoxysilyl groups or hydroxysilyl groups liable to post-crosslink with time and to occur deformation. Moreover, the post-crosslinking results in cracking when the coating film undergoes an abrupt temperature change, especially one at comparatively high temperatures.

There is another way of improving adhesion and crack resistance by controlling the difference in linear expansion coefficient between the substrate and the acrylic resin layer as a primer layer and between the primer layer and the polysiloxane curing layer. See JP-A 2004-1393. The disadvantage of this idea is that the primer layer cannot be incorporated with a large amount of ultraviolet-absorbing agent and hence is unsatisfactory in long-term weather resistance.

The above-mentioned article made up of an organic resin substrate and a laminate layer formed thereon which is composed of an undercoating film and a polysiloxane hard top coating film, needs manufacturing steps to apply at least two coating compounds. The necessity for such complicated materials and processes poses problems, and hence there has arisen a demand for simpler materials and processes.

### SUMMARY OF THE INVENTION

It is an object of the present invention to provide a hard coating composition and an article with the hard coating, the composition forming a coating film excelling in weather resistance as well as scratch resistance which is free from such defects as cracking, peeling, and yellowing for a long period of time.

The present inventors found that covering on the surface of an organic resin substrate with a hard coating film of a compound for hard coating composed of (1) a specific silicone resin component and (2) a vinyl copolymer component having organic ultraviolet-absorbing groups and reactive groups in the side chains can replace the conventional system that needs at least two layers (an undercoating layer and a hard coating layer) on the organic resin substrate, especially the substrate of polycarbonate moldings with a new simple system that merely needs at least one weather-resistant hard coating layer on the substrate of polycarbonate moldings. The weather-resistant hard coating layer is formed from a compound for weather-resistant hard coating composed of (1) a specific silicone resin component and (2) a vinyl copolymer component having specific organic ultraviolet-absorbing groups and reactive groups in the side chains. It has good abrasion resistance presumably due to the silicone resin as component (1), good adhesion to the substrate due to the vinyl copolymer as component (2), and outstanding weather resistance due to the organic ultraviolet-absorbing groups in the vinyl copolymer as component (2).

The coating film formed from the compound for weather-resistant hard coating composed of (1) a specific silicone resin component and (2) a vinyl copolymer which has organic ultraviolet-absorbing groups and reactive groups bonding to the side chain exhibits good scratch resistance owing to the siloxane crosslinking reaction between silanol groups in the silicone resin as component (1) and/or the crosslinking reaction between the silanol group and the reactive group in the vinyl copolymer as component (2). Moreover, the coating film exhibits greatly improved weather resistance over so long a period of time because the vinyl copolymer as component (2) has organic ultraviolet-absorbing groups bonding to the side chain and undergoes crosslinking in the coating film of the compound, so that the ultraviolet-absorbing groups become immobilized in the coating film and hardly migrate to the surface of the coating film, which prevents whitening of appearance and decrease in adhesion and contributes to prolonged UV-absorbing effect without the UV-absorbing groups leaching away into water solvents and evaporating from the coating film during heat-curing treatment at high temperatures.

The present invention provides a hard coating composition as a protective film having weather resistance and scratch resistance and also provides an article coated with a cured product of the composition.

[1] A weather-resistant hard coating composition to be used for direct coating on at least one surface of an organic resin substrate, said composition comprising the following components:

(1) a silicone resin resulting from (co)hydrolysis and condensation of at least one selected from those alkoxysilanes represented by the following formulas (1-1), (1-2), and (1-3) or condensates of their partial hydrolyzates,

(R¹)ₘ(R²)ₙSi(OR³)₄₋ₘ₋ₙ (1-1)

wherein R¹ and R² are independently a hydrogen atom or an unsubstituted or substituted monovalent hydrocarbon group, in which the substituent groups may be connected each other, R³ is an alkyl group having 1 to 3 carbon atoms, and m and n are independently 0 or 1, with m+n being 0, 1, or 2,

(R⁴O)₃₋ₚ(R⁶)ₚSi—R⁸—Si(R⁷)_{q}(OR⁵)_{3-q} (1-2)

wherein R⁴ and R⁵ are independently an alkyl group having 1 to 3 carbon atoms, R⁶ and R⁷ are independently a hydrogen atom or an unsubstituted or substituted monovalent hydrocarbon group, R⁸ is an oxygen atom, phenylene group, or an unsubstituted or substituted alkylene group having 2 to 10 carbon atoms, and p and q are independently 0 or 1,

X—[(R¹⁵)Si(R¹⁶)_{y}(OR¹⁷)_{3-y}]_{z} (1-3)

wherein X is a 1,3,5-trimethylcyclotrisiloxane residue, 1,3,5,7-tetramethylcyclotetrasiloxane residue, or isocyanurate residue, R¹⁵ is an alkylene group having 1 to 3 carbon atoms, R¹⁶ is a hydrogen atom or an unsubstituted or substituted monovalent hydrocarbon group, R¹⁷ is an alkyl group having 1 to 3 carbon atoms, y is 0 or 1, and z is 3 or 4;

(2) a vinyl copolymer having in its side chain an organic ultraviolet-absorbing group and a reactive group selected from an alkoxysilyl group, hydroxyl group, epoxy group, carboxylic acid group, and amino group;

(3) a curing catalyst; and

(4) a solvent;

wherein the silicone resin as component (1) and the vinyl copolymer as component (2) are present in such amounts in terms of solids that the ratio of (1)/(2) is from 10/90 to 50/50 by weight.

[2] The composition as defined in [1], wherein the silicone resin as component (1) is formed from the alkoxysilanes represented by the formulas (1-1), (1-2), and (1-3) such that the ratio of (1-1)/[(1-2)+(1-3)] is from 50/50 to 0/100 in terms of mol % of silicon.
[3] The composition as defined in [1] or [2], wherein the formula (1-1) is specified such that R¹ is a methyl group or a monovalent hydrocarbon group substituted with an ultraviolet-absorbing group, m=1, n=0, and R³ is a methyl group; the formula (1-2) is specified such that R⁸ is an unsubstituted or substituted alkylene group having 2 to 8 carbon atoms, p and q each are 0, R⁴ and R⁵ each are a methyl group; and the formula (1-3) is specified such that X is an isocyanurate residue, y=0, R¹⁷ is a methyl group, and z=3.
[4] The composition as defined in any one of [1] to [3], wherein the silicone resin as component (1) is obtained by hydrolysis and condensation from at least one selected from the group consisting of the alkoxysilanes represented by the formulas (1-2) and (1-3) and the condensates of partial hydrolyzates thereof.
[5] The composition as defined in any one of [1] to [3], wherein the silicone resin as component (1) is obtained by hydrolysis and condensation of at least one selected from the group consisting of the alkoxysilanes represented by the formula (1-3) and the condensates of partial hydrolyzes thereof.
[6] The composition as defined in any one of [1] to [5], wherein the component (2) is a copolymer obtained by copolymerization from the following monomer components (2-1) to (2-3):

(2-1) a vinyl monomer having an organic ultraviolet-absorbing group: 5 to 50% by weight;

(2-2) a reactive group-containing vinyl monomer which contains at least one selected from the group consisting of alkoxysilyl group, hydroxyl group, and epoxy group: 2 to 30% by weight; and

(2-3) other monomer copolymerizable with said monomers: 20 to 93% by weight.

[7] The composition as defined in [6], wherein the component (2-2) is a hydroxyl group-containing vinyl monomer.
[8] The composition as defined in any one of [1] to [7], which further comprises water as component (5).
[9] The composition as defined in any one of [1] to [8], which further comprises inorganic oxide fine particles as component (6).
[10] The composition as defined in [9], wherein the component (6) is at least one selected from the group consisting of silica, zinc oxide, titanium oxide, and cerium oxide.
[11] The composition as defined in any one of [1] to [10], which further comprises any organic ultraviolet-absorbing agent and/or organic ultraviolet light stabilizer other than the component (2).
[12] A coated article comprising an organic resin substrate and a hard coating film formed directly on at least one surface thereof from the weather-resistant hard coating composition as defined in any one of [1] to [11], said coated article having the property that it passes the adhesion test in a ratio of at least 97% and it gives a ΔHz (delta haze) value less than 15% in the Taber abrasion test.
[13] The coated article as defined in [12], in which the organic resin substrate is a molded one formed from polycarbonate resin.

### ADVANTAGEOUS EFFECTS OF INVENTION

The composition for weather-resistant hard coating according to the present invention gives rise to an ultraviolet-absorbing protective coating film which excels in water resistance, solvent resistance, and light resistance because it contains therein a large amount of organic ultraviolet-absorbing substance for improved light resistance, which becomes immobilized due to siloxane crosslinking without being lost for a long time, the crosslinking between the vinyl copolymer and the silicone resin forming an organic-inorganic complex which functions as a weather-resistant binder with a low linear expansion coefficient. Upon application by coating and ensuing curing to an article poor in weather resistance, the composition for weather-resistance hard coating protects the article against discoloration and deterioration and imparts good weather resistance to the article.

The composition according to the present invention will find use as a coating material for organic resin articles, especially those of polycarbonate resin. The resulting coated articles excel in not only clarity and weather resistance but also scratch resistance and chemical resistance, and hence they will be suitable for outdoor use as vehicle and aircraft window panes and wind shields, building window panes, and road sound barriers.

In addition, the composition according to the present invention permits production of coated articles by a simpler process than before.

### DESCRIPTION OF THE EMBODIMENTS

The composition for weather-resistant hard coating according to the present invention is composed of (1) a specific silicone resin, (2) a vinyl copolymer with side chains having organic ultraviolet-absorbing groups and reactive groups connected thereto, (3) a curing catalyst, and (4) a solvent, as essential components.

### Silicone Resin as Component (1)

The composition according to the present invention contains a specific silicone resin as the component (1). This component is obtained by (co)hydrolysis and condensation from at least one selected from alkoxysilanes represented by the formulas (1-1), (1-2), and (1-3) below and the condensates of partial hydrolyzates thereof.

(R¹)ₘ(R²)ₙSi(OR³)₄₋ₘ₋ₙ (1-1)

wherein R¹ and R² are independently a hydrogen atom or an unsubstituted or substituted monovalent hydrocarbon group, in which the substituent groups may be connected each other, R³ is an alkyl group having 1 to 3 carbon atoms, and m and n are independently 0 or 1, with m+n being 0, 1, or 2.

(R⁴O)₃₋ₚ(R⁶)ₚSi—R⁸—Si(R⁷)_{q}(OR⁵)_{3-q} (1-2)

wherein R⁴ and R⁵ are independently an alkyl group having 1 to 3 carbon atoms, R⁶ and R⁷ are independently a hydrogen atom or an unsubstituted or substituted monovalent hydrocarbon group, R⁸ is an oxygen atom, phenylene group, or an unsubstituted or substituted alkylene group having 2 to 10 carbon atoms, and p and q are independently 0 or 1.

X—[(R¹⁵)Si(R¹⁶)_{y}(OR¹⁷)_{3-y}]_{z} (1-3)

wherein X is a 1,3,5-trimethylcyclotrisiloxane residue, 1,3,5,7-tetramethylcyclotetrasiloxane residue, or isocyanurate residue, R¹⁵ is an alkylene group having 1 to 3 carbon atoms, R¹⁶ is a hydrogen atom or an unsubstituted or substituted monovalent hydrocarbon group, R¹⁷ is an alkyl group having 1 to 3 carbon atoms, y is 0 or 1, and z is 3 or 4.

In the formula (1-1), R¹ and R² each are a hydrogen atom or an unsubstituted or substituted monovalent hydrocarbon group, preferably one having 1 to 30 carbon atoms, particularly 1 to 20 carbon atoms. Examples of R¹ and R² include hydrogen atoms; alkyl groups such as methyl group, ethyl group, propyl group, butyl group, pentyl group, hexyl group, heptyl group, and octyl group; cycloalkyl groups such as cyclopentyl group and cyclohexyl group; alkenyl groups such as vinyl group and allyl group; aryl groups such as phenyl group; halogenated hydrocarbon groups such as chloromethyl group, γ-chloropropyl group, and 3,3′,3″-trifluoropropyl group; and other groups such as γ-methacryloxypropyl group, γ-glycidoxypropyl group, 3,4-epoxycyclohexylethyl group, γ-mercaptopropyl group, γ-aminopropyl group, γ-isocyanatepropyl group, hydroxybenzophenoneoxypropyl group, (meth)acryloxy group, epoxy group, mercapto group, amino group, isocyanate group, and hydrocarbon group substituted with an ultraviolet-absorbing group. Additional examples include those groups with substituents joining together, which are exemplified by isocyanurate groups in which isocyanate-substituted hydrocarbon groups join together. Among these examples, alkyl groups and hydrocarbon groups substituted with an ultraviolet-absorbing group are desirable particularly for applications that need scratch resistance and weather resistance, and epoxy group, (meth)acryloxy group, and isocyanurate-substituted hydrocarbon group are desirable for applications that need toughness and dyeability.

In the formula (1), R³ is an alkyl group having 1 to 3 carbon atoms, such as methyl group, ethyl group, n-propyl group, and i-propyl group. Of these examples, methyl group and ethyl group are preferable, especially methyl group is preferable, from the standpoint of their high reactivity for hydrolysis and condensation and their reaction product (R³OH alcohol) which can be easily distilled off on account of its high vapor pressure.

Examples of the compound represented by the formula (1-1) above in which m=0 and n=0 include tetraalkoxysilane represented by the formula of Si(OR³)₄ or the condensate of partial hydrolyzate thereof. Specific examples of such tetraalkoxysilane or the condensate of partial hydrolyzate thereof include: tetramethoxysilane, tetraethoxysilane, tetraisopropoxysilane, tetrabutoxysilane, condensate of partial hydrolyzate of tetramethoxysilane (“M silicate 51” from Tama Chemicals Co., Ltd.; “MSI 51” from Colcoat Co., Ltd.; and “MS 51” and “MS 56” from Mitsubishi Chemical Corporation), condensate of partial hydrolyzate of tetraethoxysilane (“Silicate 35” and “Silicate 45” from Tama Chemicals Co., Ltd. and “ESI 40” and “ESI 48” from Colcoat Co., Ltd.), and cocondensate of partial hydrolyzates of tetramethoxysilane and tetraethoxysilane (“FR-3” from Tama Chemicals Co., Ltd. and “EMSi 48” from Colcoat Co., Ltd.).

Examples of the compound represented by the formula (1-1) above in which m=1 and n=0, or m=0 and n=1, include trialkoxysilane represented by the formula of R¹Si(OR³)₃ or R²Si(OR³)₃ or the condensate of partial hydrolyzate thereof. Specific examples of such trialkoxysilane or the condensate of partial hydrolyzate thereof include: hydrogentrimethoxysilane, hydrogentriethoxysilane, methyltrimethoxysilane, methyltriethoxysilane, methyltriisopropoxysilane, ethyltrimethoxysilane, ethyltriethoxysilane, ethyltriisopropoxysilane, propyltrimethoxysilane, propyltriethoxysilane, propyltriisopropoxysilane, phenyltrimethoxysilane, vinyltrimethoxysilane, allyltrimethoxysilane, γ-methacryloxypropyltrimethoxysilane, γ-methacryloxypropyltriethoxysilane, γ-acryloxypropyltrimethoxysilane, γ-glycidoxypropyltrimethoxysilane, γ-glycidoxypropyltriethoxysilane, β-(3,4-epoxycyclohexyl)ethyltrimethoxysilane, γ-chloropropyltrimethoxysilane, 3,3,3-trifluoropropyltrimethoxysilane, 3,3,3-trifluoropropyltriethoxysilane, perfluorooctylethyltrimethoxysilane, γ-mercaptopropyltrimethoxysilane, γ-aminopropyltrimethoxysilane, γ-aminopropyltriethoxysilane, N-(2-aminoethyl)aminopropyltrimethoxysilane, γ-isocyanatepropyltrimethoxysilane, γ-isocyanatepropyltriethoxysilane, hydroxybenzophenoneoxypropyltrimethoxysilane, condensate of partial hydrolyzate of methyltrimethoxysilane (“KC-89S” and “X-40-9220” from Shin-Etsu Chemical Co., Ltd.), and condensate of partial hydrolyzate of methyltrimethoxysilane and γ-glycidoxypropyltrimethoxysilane (“X-41-1056” from Shin-Etsu Chemical Co., Ltd.).

Examples of the compound represented by the formula (1-1) above in which m=1 and n=1 include dialkoxysilane represented by the formula of (R¹)(R²)Si(OR³)₂ or the condensate of partial hydrolyzate thereof. Specific examples of such dialkoxysilane or the condensate of partial hydrolyzate thereof include: methylhydrogendimethoxysilane, methylhydrogendiethoxysilane, dimethyldimethoxysilane, dimethyldiethoxysilane, methylethyldimethoxysilane, diethyldimethoxysilane, diethyldiethoxysilane, methylpropyldimethoxysilane, methylpropyldiethoxysilane, diisopropyldimethoxysilane, phenylmethyldimethoxysilane, vinylmethyldimethoxysilane, γ-glycidoxypropylmethyldimethoxysilane, γ-glycidoxypropylmethyldiethoxysilane, β-(3,4-epoxycyclohexyl)ethylmethyldimethoxysilane, γ-methacryloxypropylmethyldimethoxysilane, γ-methacryloxypropylmethyldiethoxysilane, γ-mercaptopropylmethyldimethoxysilane, γ-aminopropylmethyldiethoxysilane, N-(2-aminoethyl)aminopropylmethyldimethoxysilane, hydroxybenzophenoneoxypropylmethyldimethoxysilane, and condensate of partial hydrolyzate thereof.

Preferable among those compounds represented by the formula (1-1) are methyltrimethoxysilane, condensate of partial hydrolyzate thereof (“KC-89S” and “X-40-9220” from Shin-Etsu Chemical Co., Ltd.), and hydroxybenzophenoneoxypropyltrimethoxysilane.

Examples of the second alkoxysilane or condensate of partial hydrolyzate thereof include those compounds represented by the formula (1-2) below.

(R⁴O)₃₋ₚ(R⁶)ₚSi—R⁸—Si(R⁷)_{q}(OR⁵)_{3-q} (1-2)

wherein R⁴ and R⁵ are independently an alkyl group having 1 to 3 carbon atoms; R⁶ and R⁷ are independently a hydrogen atom or an unsubstituted or substituted monovalent hydrocarbon group; R⁸ is an oxygen atom, phenylene group, or unsubstituted or substituted alkylene group having 2 to 10 carbon atoms; and p and q are independently 0 or 1.

In the formula (1-2), R⁴ and R⁵ are independently an alkyl group having 1 to 3 carbon atoms, such as methyl group, ethyl group, n-propyl group, and i-propyl group. Of these examples, methyl group and ethyl group are preferable, especially methyl group is preferable, from the standpoint of their high reactivity for hydrolysis and condensation and their reaction product (R³OH alcohol) which can be easily distilled off on account of its high vapor pressure.

In the formula (1-2), R⁶ and R⁷ each are a hydrogen atom or an unsubstituted or substituted monovalent hydrocarbon group, preferably one having 1 to 12 carbon atoms, particularly 1 to 8 carbon atoms. Examples of R⁶ and R⁷ include hydrogen atoms; alkyl groups such as methyl group, ethyl group, propyl group, butyl group, pentyl group, hexyl group, heptyl group, and octyl group; cycloalkyl groups such as cyclopentyl group and cyclohexyl group; alkenyl groups such as vinyl group and allyl group; aryl groups such as phenyl group; halogenated hydrocarbon groups such as chloromethyl group, γ-chloropropyl group, and 3,3′,3″-trifluoropropyl group; and other groups such as γ-methacryloxypropyl group, γ-glycidoxypropyl group, 3,4-epoxycyclohexylethyl group, γ-mercaptopropyl group, γ-aminopropyl group, γ-isocyanatepropyl group, (meth)acyloxy group, epoxy group, mercapto group, amino group, and hydrocarbon group substituted with isocyanate group. Among these examples, alkyl groups, especially methyl group, are desirable particularly for applications that need scratch resistance and weather resistance.

In the formula (1-2), R⁸ is an oxygen atom, phenylene group, or an unsubstituted or substituted monovalent alkylene group having 2 to 10 carbon atoms. Preferable among divalent alkylene groups are unsubstituted or halogenated alkylene groups having 2 to 10 carbon atoms as exemplified below: ethylene group, 1,3-propylene group, 1,4-butylene group, 1,6-hexylene group, 1,8-octylene group, 3,3,4,4,5,5,6,6-octafluoro-1,8-octylene group, 1,10-decylene group, and 3,3,4,4,5,5,6,6,7,7,8,8-dodecafluoro-1,10-decylene. Of these examples, those unsubstituted or halogenated alkylene groups having 2 to 10 carbon atoms listed below are preferable for applications that need scratch resistance and weather resistance: ethylene group, 1,6-hexylene group, 3,3,4,4,5,5,6,6-octafluoro-1,8-octylene group, 1,10-decylene group, and 3,3,4,4,5,5,6,6,7,7,8,8-dodecafluoro-1,10-decylene group.

Examples of the compound represented by the formula (1-2) above include bisalkoxysilane or the condensate of partial hydrolyzate thereof. Specific examples of such bisalkoxysilane or the condensate of partial hydrolyzate thereof include: 1,2-ethylenebis(trimethoxysilane), 1,2-ethylenebis(methyldimethoxysilane), 1,6-hexylenebis(trimethoxysilane), 1,6-hexylenebis(methyldimethoxysilane), 3,3,4,4,5,5,6,6-octafluoro-1,8-octylenebis(trimethoxysilane), and 3,3,4,4,5,5,6,6-octafluoro-1,8-octylenebis-(methyldimethoxysilane).

The third alkoxysilane or the condensate of partial hydrolyzate thereof is exemplified by those represented by the formula (1-3) below.

X—[(R¹⁵)Si(R¹⁶)_{y}(OR¹⁷)_{3-y}]_{z} (1-3)

wherein X is a 1,3,5-trimethylcyclotrisiloxane residue, 1,3,5,7-tetramethylcyclotetrasiloxane residue, or isocyanurate residue; R¹⁵ is an alkylene group having 1 to 3 carbon atoms; R¹⁵ is a hydrogen atom or an unsubstituted or substituted monovalent hydrocarbon group; R¹⁷ is an alkyl group having 1 to 3 carbon atoms; y is 0 or 1; and z is 3 or 4.

In the formula (1-3), X is a 1,3,5-trimethylcyclotrisiloxane residue (represented by the formula (i) below), 1,3,5,7-tetramethylcyclotetrasiloxane residue (represented by the formula (ii) below), or isocyanurate residue (represented by the formula (iii) below), with the last one being preferable.

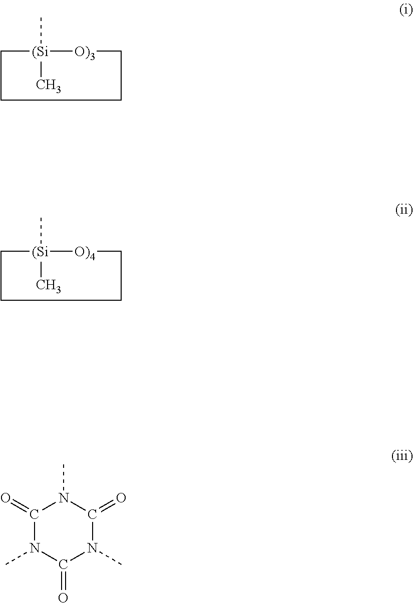

wherein the chain line denotes the bonding hand.

In the formula (1-3), R¹⁵ is an alkylene group having 1 to 3 carbon atoms, such as methylene group, ethylene group, 1,2-propylene group, and 1,3-propylene group, with the last one being preferable.

R¹⁶ is the same groups as R⁶ and R⁷ in the formula (1-2). Likewise, R¹⁷ is the same groups as R⁴ and R⁵ in the formula (1-2).

Examples of the compound represented by the formula (1-3) include:
1,3,5-trimethyl-1,3,5-tris(3-trimethoxysilylpropyl)-cyclotrisiloxane,
1,3,5-trimethyl-1,3,5-tris(3-triethoxysilylpropyl)-cyclotrisiloxane,
1,3,5,7-tetramethyl-1,3,5,7-tetrakis(3-trimethoxysilyl-propyl)cyclotetrasiloxane,
1,3,5,7-tetramethyl-1,3,5,7-tetrakis(3-triethoxysilylpropyl)-cyclotetrasiloxane,
tris(3-trimethoxysilylpropyl)isocyanurate, and
tris(3-triethoxysilylpropyl)isocyanurate.

Preferable among those compounds represented by the formulas (1-1) to (1-3) are the one represented by the formula (1-1) in which R¹ is a methyl group or a monovalent hydrocarbon group substituted with an ultraviolet-absorbing group, m=1 and n=0, and R³ is a methyl group, the one represented by the formula (1-2) in which R⁸ is an unsubstituted or substituted alkylene group having 2 to 8 carbon atoms, p and q=0, R⁴ and R⁵ each are a methyl group, and the one represented by the formula (1-3) in which X is an isocyanurate residue, y=0, R¹⁷ is a methyl group, and z=3.

The silicone resin as the component (1) may be prepared from the components (1-1) to (1-3) mentioned above in any ratio. For improved weather resistance and scratch resistance, it should preferably be formed from them in such amounts that the ratio of (1-1)/[(1-2)+(1-3)] ranges from 50/50 to 0/100, more preferably 30/70 to 0/100 (in terms of the molar ratio of Si). If the total amount of the components (1-2) and (1-3) is less than 50 Si mol %, the resulting hard coating may not be sufficiently hard on account of the low crosslink density.

Incidentally, the Si mol % implies the ratio in the total amount of Si (in mol). One mol equals the molecular weight in the case of a monomer or the average molecular weight divided by 2 in the case of a dimer.

The silicone resin as the component (1) may be prepared from the components (1-1) to (1-3) mentioned above by (co)hydrolysis and condensation in any known way. A typical method includes (co)hydrolyzing alkoxysilane or the condensate of partial hydrolyzate thereof of the components (1-1), (1-2), and (1-3) separately or together in water at pH 1 to 7.5, preferably pH 2 to 7. The water may contain metal oxide fine particles such as silica sol suspended therein. In addition, the water may contain one of the following compounds as a pH adjustor or an acid catalyst to promote hydrolysis. Examples include organic or inorganic acids such as hydrofluoric acid, hydrochloric acid, nitric acid, formic acid, acetic acid, propionic acid, oxalic acid, citric acid, maleic acid, benzoic acid, malonic acid, glutaric acid, glycolic acid, methanesulfonic acid, and toluenesulfonic acid; cation exchange resin coated with carboxylic acid group or sulfonic acid group; and metal oxide fine particles, such as silica sol, dispersible in acid water. Hydrolysis may be carried out in the presence of inorganic oxide fine particles such as silica sol, dispersed in water or organic solvent.

The hydrolysis should be carried out with water in an amount of 20 to 3,000 parts by weight for the total amount (100 parts by weight) of the components (1-1), (1-2), and (1-3) as alkoxysilane and/or condensate of partial hydrolyzate thereof. An excessive amount of water hinders efficient operation and makes the final composition poor in coatability and dryability due to the remaining water. Moreover, for improved storage stability, scratch resistance, and crack resistance, the amount of water should be at least 50 parts by weight and up to 150 parts by weight. With an excessively small amount of water, the resulting silicone resin will not have a sufficiently large weight average molecular weight within the adequate range specified later.

The molecular weight is one in terms of polystyrene which is determined by gel permeation chromatography (GPC). With an excessively large amount of water, the resulting silicone resin will not have a weight average molecular weight sufficient for the hard coating to have crack resistance as desired.

The hydrolysis may be accomplished by adding water to alkoxysilane or condensate of partial hydrolyzate thereof dropwise or all at once, and vice versa. The water for hydrolysis may contain an organic solvent, although the use of the organic solvent is not so recommended. Organic solvent-containing water tends to give rise to a silicone resin having a small weight average molecular weight in terms of polystyrene determined by GPC.

The hydrolysis is directly followed by condensation to give the silicone resin as the component (1). Condensation, which directly follows hydrolysis, is carried out at normal temperature or with heating under 100° C. Condensation at temperatures higher than 100° C. will cause gelation. It is possible to accelerate condensation by distillation of the alcohol resulting from hydrolysis with heating above 80° C. under normal pressure or reduced pressure. It is also possible to accelerate condensation by addition of a curing catalyst, such as basic compound, acid compound, and metal chelate compound. Before or during condensation, the liquid for condensation may be incorporated with an organic solvent to adjust the rate of condensation and to adjust the concentration, or with inorganic fine particles (such as silica sol) dispersed in water or organic solvent. The silicone resin usually increases in molecular weight according as condensation proceeds, thereby decreasing in solubility in water and alcohol resulting from hydrolysis.

Consequently, the solvent to be added should preferably be an organic one with a relatively high polarity which readily dissolves the silicone resin and has a boiling point of at least 80° C. Examples of such organic solvents are listed below. Alcohols, such as isopropyl alcohol, n-butanol, isobutanol, t-butanol, and diacetone alcohol; ketones, such as methyl propyl ketone, diethyl ketone, methyl isobutyl ketone, cyclohexanone, and diacetone alcohol; ethers, such as dipropyl ether, dibutyl ether, anisole, dioxane, ethylene glycol monoethyl ether, ethylene glycol monobutyl ether, propylene glycol monomethyl ether, propylene glycol monomethyl ether acetate; and esters, such as propyl acetate, butyl acetate, and cyclohexyl acetate.

The silicone resin obtained by hydrolysis and ensuing condensation should have a weight average molecular weight (in terms of polystyrene determined by GPC) of at least 1,500, preferably from 1,500 to 50,000, more preferably from 2,000 to 20,000. With a molecular weight smaller than the lower limit, the silicone resin will give rise to a coating film poor in toughness and liable to cracking. With a molecular weight larger than the upper limit, the silicone resin will give rise to a coating film poor in hardness and liable to whitening due to phase separation therein.

The composition for weather-resistant hard coating contains the second component (2), which is a vinyl copolymer having organic ultraviolet-absorbing groups and reactive groups in the side chain thereof. The vinyl copolymer should preferably be constructed such that the organic ultraviolet-absorbing groups as well as the reactive groups bond to the main chain thereof. This copolymer may be obtained by copolymerization from the vinyl monomer having organic ultraviolet-absorbing groups as the component (2-1), the vinyl monomer having reactive groups as the component (2-2), and the other monomer as the component (2-3) capable of copolymerization with above-mentioned monomers.

No specific restrictions are imposed on the vinyl monomer having organic ultraviolet-absorbing groups as the component (2-1) so long as it contains polymerizable vinyl groups and ultraviolet-absorbing groups in the molecule thereof.

A typical example of the vinyl monomer having organic ultraviolet-absorbing groups as the component (2-1) is a (meth)acrylic monomer having an ultraviolet-absorbing group in the molecule thereof. It includes a benzotriazole compound represented by the formula (2-1-1) below and a benzophenone compound represented by the formula (2-1-2) below.

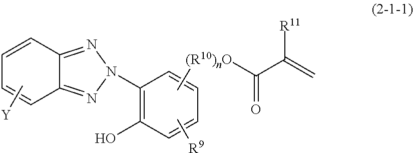

wherein Y is a hydrogen atom or chlorine atom; R⁹ is a hydrogen atom, methyl group, or tertiary alkyl group having 4 to 8 carbon atoms; R¹⁰ is a linear or branched alkylene group having 2 to 10 carbon atoms; R¹¹ is a hydrogen atom or methyl group; and n is 0 or 1.

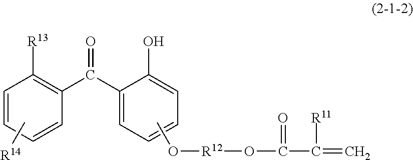

wherein R¹¹ is defined as above; R¹² is a unsubstituted or substituted linear or branched alkylene group having 2 to 10 carbon atoms; R¹³ is a hydrogen atom or hydroxyl group; and R¹⁴ is a hydrogen atom, hydroxyl group, or an alkoxyl group having 1 to 6 carbon atoms.

Examples of the C₄₋₈ tertiary alkyl group represented by R⁹ in the formula (2-1-1) above include tert-butyl group, tert-pentyl group, tert-hexyl group, tert-heptyl group, tert-octyl group, and di-tert-octyl group.

Examples of the linear or branched C₂₋₁₀ alkylene group represented by R¹⁰ in the formula (2-1-1) above include ethylene group, trimethylene group, propylene group, tetramethylene group, 1,1-dimethyltetramethylene group, butylene group, octylene group, and decylene group.

Examples of the linear or branched C₂₋₁₀ alkylene group represented by R¹² in the formula (2-1-2) above include the same one as represented by R¹⁰, with or without the hydrogen atoms therein partially replaced by halogen atoms. Examples of the C₁₋₆ alkoxyl group represented by R¹⁴ include methoxy group, ethoxy group, propoxy group, and butoxy group.

Examples of the benzotriazole compound represented by the formula (2-1-1) above include 2-(2′-hydroxy-5′-(meth)acryloxyphenyl)-2H-benzotriazole,
2-(2′-hydroxy-3′-tert-butyl-5′-(meth)acryloxymethylphenyl)-2H-benzotriazole,
2-[2′-hydroxy-5′-(2-(meth)acryloxyethyl)phenyl]-2H-benzotriazole,
2-[2′-hydroxy-3′-tert-butyl-5′-(2-(meth)acryloxyethyl)-phenyl]-5-chloro-2H-benzotriazole, and
2-[2′-hydroxy-3′-methyl-5′-(8-(meth)acryloxyoctyl)phenyl]-2H-benzotriazole.

Examples of the benzophenone compound represented by the formula (2-1-2) above include the following.
2-hydroxy-4-(2-(meth)acryloxyethoxy)benzophenone,
2-hydroxy-4-(4-(meth)acryloxybutoxy)benzophenone,
2,2′-dihydroxy-4-(2-(meth)acryloxyethoxy)benzophenone,
2,4-dihydroxy-4′-(2-(meth)acryloxyethoxy)benzophenone,
2,2′,4-trihydroxy-4′-(2-(meth)acryloxyethoxy)benzophenone,
2-hydroxy-4-(3-(meth)acryloxy-2-hydroxypropoxy)benzophenone,
and 2-hydroxy-4-(3-(meth)acryloxy-1-hydroxypropoxy)benzophenone.

Examples of the ultraviolet-absorbing vinyl monomer mentioned above include benzotriazole compounds represented by the formula (2-1-1). Preferable among them is 2-[2′-hydroxy-5′-(2-(meth)acryloxyethyl)phenyl]-2H-benzotriazole. Moreover, the ultraviolet-absorbing vinyl monomers may be used alone or in combination with at least one another.

The vinyl monomer having an organic ultraviolet-absorbing group, as the component (2-1), should be used in an amount of 5 to 50% by weight, preferably 5 to 30% by weight for the total amount of the copolymer. With an amount less than 5% by weight, it does not give good weather resistance. With an amount more than 50% by weight, it adversely affects the adhesion of the coating film and causes the whitening of the coating film (which makes the coating film look poor).

The vinyl monomer having a reactive group, as the component (2-2), is not specifically restricted so long as it contains one polymerizable vinyl functional group and one or more reactive groups in one molecule.

Examples of the polymerizable vinyl functional group include organic groups having 2 to 12 carbon atoms such as vinyl group, vinyloxy group, (meth)acryloxy group, and (α-methyl)styryl group. Typical examples include vinyl group, 5-hexenyl group, 9-decenyl group, vinyloxymethyl group, 3-vinyloxypropyl group, and (meth)acryloxy group. Of these examples, (meth)acryloxy group is desirable because of its reactivity and availability.

Examples of the reactive group include alkoxysilyl group, hydroxyl group, epoxy group, carboxylic group, and amino group. Of these examples, alkoxysilyl group, hydroxyl group, and epoxy group are desirable because of their reactivity and availability.

Examples of the vinyl monomer having the reactive group, as the component (2-2), include those having a hydroxyl group such as: 2-hydroxyethyl methacrylate, 2-hydroxypropyl methacrylate, 3-hydroxypropyl methacrylate, 2-hydroxybutyl methacrylate, 4-hydroxybutyl methacrylate, 3-chloro-2-hydroxypropyl methacrylate, polyethyleneglycol methacrylate, polypropyleneglycol methacrylate, poly(ethyleneglycolpropyleneglycol) methacrylate, poly(ethyleneglycoltetramethyleneglycol) methacrylate, poly(propyleneglycoltetramethyleneglycol) methacrylate, glycerol methacrylate, polycaprolactone methacrylate, acrylates thereof, hydroxyethyl vinyl ether, hydroxypropyl vinyl ether, hydroxybutyl vinyl ether, diethylene glycol monovinyl ether, and cyclohexenedimethanol divinyl ether. Of these examples, 2-hydroxyethyl methacrylate, 3-hydroxypropyl methacrylate, and 4-hydroxybutyl methacrylate and acrylates thereof are preferable because of their reactivity and availability.

Examples of the vinyl monomer having the reactive group, as the component (2-2), include those having an alkoxysilyl group as listed below. Methacryloxymethyltrimethoxysilane, methacryloxypropyltrimethoxysilane, methacryloxyundecyltrimethoxysilane, methacryloxypropylmethyldimethoxysilane, methacryloxypropyldimethylmethoxysilane, methacryloxypropyltriethoxysilane, acryloxypropyltrimethoxysilane, acryloxypropylmethyldimethoxysilane, acryloxypropyldimethylmethoxysilane, acryloxypropyltriethoxyilane, acryloxymethyltrimethoxysilane, acryloxyundecyltrimethoxysilane, vinyltrimethoxysilane, vinyltriethoxysilane, vinylmethyldimethoxysilane, allyltrimethoxysilane, styryltrimethoxysilane, styrylmethyldimethoxysilane, and styryltriethoxysilane. Of these examples, the following are preferable because of their availability, handling properties, crosslink density, and reactivity. Methacryloxypropyltrimethoxysilane, methacryloxypropylmethyldimethoxysilane, methacryloxypropyldimethylmethoxysilane, acryloxypropyltrimethoxysilane, and acryloxypropylmethyldimethoxysilane.

Examples of the vinyl monomer having the reactive group, as the component (2-2), also include glycidyl methacrylate having an epoxy group.

Examples of the vinyl monomer having the reactive group, as the component (2-2), also include those compounds having a hydroxyl group as listed below.

2-hydroxyethyl methacrylate, 2-hydroxypropyl methacrylate, 3-hydroxypropyl methacrylate, 2-hydroxybutyl methacrylate, and 4-hydroxybutyl methacrylate, and acrylates thereof.

The vinyl monomer having a reactive group, as the component (2-2), should be used in an amount of 2 to 30% by weight, preferably 3 to 20% by weight, for the total amount of the copolymer. If the amount is less than 2% by weight, the resulting vinyl copolymer is poor in compatibility with the silicone resin as the component (1), which leads to the whitening of the coating film. In addition, the vinyl monomer in an insufficient amount does not form complete three-dimensional crosslinking between the reactive group in the vinyl copolymer and the silanol group in the silicone resin, which prevents the coating film from improving in heat resistance and durability. By contrast, if the amount exceeds 30% by weight, the resulting vinyl copolymer has an excessively high polarity and the coating film will be poor in adhesion after dipping in boiling water.

The vinyl monomer having a reactive group as the component (2-2) may be used alone or in combination with at least one another.

The other monomer (2-3) copolymerizable with the above-mentioned monomers (2-1) and (2-2) is not specifically restricted so long as it is capable of copolymerization. It includes, for example, (meth)acryl monomer having a cyclic hindered amine structure, (meth)acrylic ester, (meth)acryronitrile, (meth)acrylamide, alkyl vinyl ether, alkyl vinyl ester, styrene, and derivatives thereof.

Typical examples of the (meth)acryl monomer having a cyclic hindered amine structure include 2,2,6,6-tetramethyl-4-piperidinylmethacrylate and 1,2,2,6,6-pentamethyl-4-piperidinylmethacrylate. They may be used alone or in combination with at least one another. They can be used as a light stabilizer.

Typical examples of the (meth)acrylic ester and derivatives thereof include the following.

(Meth)acrylic esters of monohydric alcohol, such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, t-butyl (meth)acrylate, n-pentyl (meth)acrylate, isopentyl (meth)acrylate, n-hexyl (meth)acrylate, isohexyl (meth)acrylate, n-heptyl (meth)acrylate, isoheptyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-undecyl (meth)acrylate, n-dodecyl (meth)acrylate, lauryl (meth)acrylate, palmityl (meth)acrylate, stearyl (meth)acrylate, cyclohexyl (meth)acrylate, 4-methylcylcohexyl (meth)acrylate, 4-t-butylcyclohexyl (meth)acrylate, isobornyl (meth)acrylate, dicyclopentanyl (meth)acrylate, dicyclopentenyloxyethyl (meth)acrylate, and benzyl (meth)acrylate; (meth)acrylic esters of alkoxy(poly)alkyleneglycol, such as 2-methoxyethyl (meth)acrylate, 2-methoxypropyl (meth)acrylate, 3-methoxypropyl (meth)acrylate, 2-methoxybutyl (meth)acrylate, 3-methoxybutyl (meth)acrylate, and 4-methoxybutyl (meth)acrylate, methoxypolyethyleneglycol (meth)acrylate with 2 to 20 ethyleneglycol units and methoxypolypropyleneglycol (meth)acrylate with 2 to 20 propyleneglycol units; poly(meth)acrylic esters of polyhydric alcohol, such as ethyleneglycol di(meth)acrylate, propyleneglycol di(meth)acrylate, butyleneglycol di(meth)acrylate, glycerin di(meth)acrylate, glycerin tri(meth)acrylate, pentaerythritol di(meth)acrylate, pentaerythritol tetra(meth)acrylate, 1,4-cyclohexanediol di(meth)acrylate, polyethyleneglycol di(meth)acrylate with 2 to 20 ethyleneglycol units, and polypropyleneglycol di(meth)acrylate with 2 to 20 propyleneglycol units; (poly)esters of non-polymerizable polybasic acid with hydroxyalkyl (meth)acrylate, such as mono[2-(meth)acryloyloxyethyl]succinate, di[2-(meth)acryloyloxyethyl]succinate, mono[2-(meth)acryloyloxyethyl]adipate, di[2-(meth)acryloyloxyethyl]adipate, mono[2-(meth)acryloyloxyethyl]phthalate, and di[2-(meth)acryloyloxyethyl]phthalate; amino group-containing (meth)acrylic esters, such as 2-aminoethyl (meth)acrylate, 2-(N-methylamino)ethyl (meth)acrylate, 2-(N,N-dimethylamino)ethyl (meth)acrylate, 2-(N-ethylamino)ethyl (meth)acrylate, 2-(N,N-diethylamino)ethyl (meth)acrylate, 3-(N,N-dimethylamino)propyl (meth)acrylate, and 4-(N,N-dimethylamino)butyl (meth)acrylate; and epoxy group-containing (meth)acrylic esters, such as glycidyl (meth)acrylate.

Examples of the derivatives of (meth)acrylonitrile include α-chloroacrylonitrile, α-chloromethylacrylonitrile, α-trifluoromethylacrylonitrile, α-methoxyacrylonitrile, α-ethoxyacrylonitrile, and vinylidene cyanide.

Examples of the (meth)acrylamide include N-methyl(meth)acrylamide, N,N-dimethyl(meth)acrylamide, N-ethyl(meth)acrylamide, N,N-diethyl(meth)acrylamide, N-methoxy(meth)acrylamide, N,N-dimethoxy(meth)acrylamide, N-ethoxy(meth)acrylamide, N,N-diethoxy(meth)acrylamide, diacetone(meth)acrylamide, N-methylol(meth)acrylamide, N-(2-hydroxyethyl)(meth)acrylamide, N,N-dimethylaminomethyl(meth)acrylamide, N-(2-dimethylamino)ethyl(meth)acrylamide, N,N′-methylenebis(meth)acrylamide, and N,N′-ethylenebis(meth)acrylamide.

Examples of the alkyl vinyl ether include methyl vinyl ether, ethyl vinyl ether, butyl vinyl ether, and hexyl vinyl ether.

Examples of the alkyl vinyl ester include vinyl formate, vinyl acetate, vinyl acrylate, vinyl butyrate, vinyl caproate, and vinyl stearate.

Examples of the styrene and derivatives thereof include styrene, α-methylstyrene, and vinyltoluene.

Preferable among the foregoing monomers are derivatives of (meth)acrylic esters such as methyl (meth)acrylate, ethyl (meth)acrylate, isopropyl (meth)acrylate, n-butyl (meth)acrylate, isobutyl (meth)acrylate, n-hexyl (meth)acrylate, 2-ethylhexyl (meth)acrylate, isononyl (meth)acrylate, lauryl (meth)acrylate, cyclohexyl (meth)acrylate, 4-methylcyclohexyl (meth)acrylate, 4-t-butylcyclohexyl (meth)acrylate, isobornyl (meth)acrylate, dicyclopentanyl (meth)acrylate, dicyclopentenyloxyethyl (meth)acrylate, methacryloxypropyltrimethoxysilane, methacryloxypropylmethyldimethoxysilane, methacryloxypropyltriethoxysilane, and vinyltrimethoxysilane.

The other copolymerizable monomer (2-3) may be mixed with one or more of the foregoing monomers.

The foregoing other copolymerizable monomer (2-3) should be used in an amount of 20 to 93% by weight, preferably 50 to 92% by weight for the total amount of the copolymer. If the amount of the other copolymerizable monomer (2-3) is excessively large, the resulting vinyl copolymer is poor in heat resistance, durability, and weather resistance on account of insufficient crosslinking with the silicone resin (1).

The foregoing vinyl copolymer (2) may be obtained by copolymerization between the vinyl monomer containing an organic ultraviolet-absorbing group (2-1), the vinyl monomer containing a reactive group (2-2), and the other copolymerizable monomer (2-3). This copolymerization is facilitated by addition of a radical polymerization initiator to a solution containing the monomers and reaction with heating at 50 to 150° C., particularly 70 to 120° C. for one to ten hours, particularly three to eight hours. The initiator is one selected from peroxides such as dicumyl peroxide and benzoyl peroxide, or from azo compounds such as azobisisobutylonitrile.

The vinyl copolymer should preferably have a weight average molecular weight of 1,000 to 300,000, particularly 5,000 to 250,000, in terms of polystyrene determined by gel permeation chromatography (GPC). In the case of an excessively large molecular weight, the copolymer is difficult to produce or handle owing to an excessively high viscosity. In the case of an excessively small molecular weight, the resulting coating film is poor in appearance due to whitening, adhesion, durability, and weather resistance.

The silicone resin as the component (1) and the vinyl copolymer as the component (2) should be used in such amounts that the ratio of solids in the former to solids in the latter is from 10/90 to 50/50, particularly from 15/85 to 45/55, by weight. If the amount of the component (1) is less than the lower limit (10/90), the resulting hard coating would be poor in scratch resistance. If the amount of the component (2) is less than the lower limit (50/50), the resulting hard coating would be poor in adhesion to the substrate.

The component (3) is a curing catalyst in common use. To be specific, it is a curing catalyst that promotes the condensation reaction of the condensable groups such as silanol group and alkoxyl group contained in the silicone resin as the component (1). It includes, for example, basic compounds such as lithium hydroxide, sodium hydroxide, potassium hydroxide, sodium methylate, sodium propionate, potassium propionate, sodium acetate, potassium acetate, sodium formate, potassium formate, trimethylbenzylammonium hydroxide, tetramethylammonium hydroxide, tetramethylammium acetate, n-hexylamine, tributylamine, diazabicycloundecene (DBU), and dicyandiamide; metal-containing compounds such as tetraisopropyl titanate, tetrabutyl titanate, titanium acetylacetonate, aluminum triisobutoxide, aluminum triisopropoxide, tris(acetylacetonate) aluminum, diisopropoxy(ethylacetoacetate) aluminum, aluminum perchlorate, aluminum chloride, cobalt octylate, cobalt acetylacetonate, iron acetylacetonate, tin acetylacetonate, dibutyltin octylate, and dibutyltin laurate; and acid compounds such as p-toluenesulfonic acid and trichloroacetic acid. Preferable among these examples are sodium propionate, potassium acetate, sodium formate, trimethylbenzylammonium hydroxide, tetramethylammonium hydroxide, tris(acetylacetonate) aluminum, and diisopropoxy(ethylacetoacetate) aluminum.

The amount of the component (3) is not specifically restricted so long as it is large enough to cure the silicone resin as the component (1). Typically, it should be 0.0001 to 30% by weight, preferably 0.001 to 10% by weight for the amount of solids in the silicone resin. With an amount less than the lower limit, it does not perform curing completely, and hence the resulting hard coating is poor in hardness. If the amount exceeds the upper limit, the resulting hard coating is subject to cracking and poor in water resistance.

The component (4) is a solvent. It is not specifically restricted so long as it dissolves or disperses the components (1), (2), and (3). It should be composed mainly of an organic solvent with a high polarity. Examples of such an organic solvent include alcohols such as methanol, ethanol, isopropyl alcohol, n-butanol, isobutanol, t-butanol, and diacetone alcohol; ketones such as methyl propyl ketone, diethyl ketone, methyl isobutyl ketone, cyclohexanone, and diacetone alcohol; ethers such as dipropyl ether, dibutyl ether, anisole, dioxane, ethylene glycol monoethyl ether, ethylene glycol monobutyl ether, propylene glycol monomethyl ether, and propylene glycol monomethyl ether acetate; and esters such as ethyl acetate, propyl acetate, butyl acetate, and cyclohexyl acetate. They may be used alone or in combination with at least one another.

The component (4) should be used in an amount of 1 to 30% by weight, preferably 5 to 25% by weight for the total amount of solids in the composition for weather-resistant hard coating. With an amount less than or more than the range specified above, the component (4) would adversely affect the coating film formed from the composition by curing. In other words, in the case of insufficient amount, the resulting coating film would be uneven and poor in hardness and scratch resistance. In the case of excess amount, the resulting coating film would be subject to whitening and scratching and have a poor appearance due to stripy flow pattern.

The composition for weather-resistant hard coating may optionally contain water as component (5). This water may be newly added or may be one which remains in the silicone resin as the component (1) after (co)hydrolysis. Water as the component (5) partly accelerates the crosslinking reaction between the silicone resin as the component (1) and the reactive group-containing vinyl copolymer as the component (2), thereby facilitating the formation of the reaction product of the component (1) and the component (2). This reaction product is one which results from the curing of the composition for weather-resistant hard coating. And this curing is partly promoted by the water which previously exists in the composition.

The water to be used for this purpose is not specifically restricted; however, acidic or neutral water is preferable. The substance that makes the water acidic should preferably be one which does not remain in the coating film after the composition has been made into the hard coating. The residues of such a substance make the coating film poor in adhesion and crack resistance. An organic acid is preferable for this purpose. Examples of the organic acid include organic carboxylic acids such as formic acid, acetic acid, propionic acid, and oxalic acid. Of these examples, formic acid and acetic acid are desirable because they easily evaporate, leaving nothing behind in the coating film.

The water should be used in any amount without specific restrictions so long as it is uniformly miscible with the vinyl copolymer as the component (2). A typical amount should be less than 5 mol, preferably from 0.1 to 5 mol, and more preferably 0.3 to 3 mol, for 1 mol of the reactive group in the vinyl copolymer as the component (2). Water in an excess amount deteriorates storage stability and causes viscosity increase or gelation during storage or use.

The composition for weather-resistant hard coating may also optionally contain inorganic oxide fine particles as component (6). Examples of the inorganic oxide fine particles include silica, zinc oxide, titanium oxide, and cerium oxide. They should be added in an adequate amount in order to enhance the hardness, scratch resistance, and ultraviolet-absorbing performance of the coating film. The fine particles should preferably be those of nano size which have a particle diameter of approximately 5 to 200 nm and dispersed in water and organic solvent. Any commercial ones of aqueous dispersion type or organic dispersion type may be used. A typical example of silica is Snowtex O, OS, OL, and methanol silica sol made by Nissan Chemical Industries, Ltd.

The zinc oxide, titanium oxide, and cerium oxide should be ones which are sufficiently low in photocatalytic activity. Oxide fine particles usually act not only as an ultraviolet shield but also as a photocatalyst. If such oxide fine particles are used as an ultraviolet shield for the coating material, the resulting coating film suffers cracking because the binder deteriorates by the photocatalyst. This drawback is avoided by using the oxide fine particles which are inactive as a photocatalyst. Examples of such oxide fine particles include coated ones which are surface-coated with an oxide (such as silica) or hydroxide, preferably with additional surface treatment with a hydrolyzable silane. Such surface-coated oxide fine particles may be obtained by coating the surface of oxide fine particles with an alkoxide of Al, Si, Zr, or Sn, followed by hydrolysis which forms an oxide film, or by coating the surface of oxide fine particles with an aqueous solution of sodium silicate, followed by neutralization which causes an oxide or hydroxide to precipitate on the surface and heating which crystallizes the precipitated oxide or hydroxide. Such oxide fine particles are commercially available from CIK Nanotech K.K. under trade names of ZNTANB 15 wt %-E16, -E34, and RTTDNB 15 wt %-E68, -E88.

The inorganic oxide fine particles as the component (6) should be used in an amount of 0 to 40 parts by weight for the total amount (100 parts by weight) of the components (1), (2), and (3). If the component (6) is used, its amount should preferably be at least 2 parts by weight.

The composition may optionally be incorporated with an ultraviolet-absorbing agent and/or organic ultraviolet light stabilizer other than the component (2). Such agents should preferably be ones which are highly miscible with the composition for weather-resistant hard coating and low in volatility.

Preferable examples of the organic ultraviolet-absorbing agent are derivatives of compounds having the main skeleton of hydroxybenzophenone, benzotriazole, cyanoacrylate, or triazine. Other preferable examples are vinyl polymers or copolymers of other vinyl monomers containing the foregoing organic ultraviolet-absorbing agent in their side chain or silylated organic ultraviolet-absorbing agents or condensate of their (partial) hydrolyzate.

Typical examples of the organic ultraviolet-absorbing agents are listed below. 2,4-dihydroxybenzophenone, 2,2′,4,4′-tetrahydroxybenzophenone, 2-hydroxy-4-methoxybenzophenone, 2-hydroxy-4-methoxybenzophenone-5-sulfonic acid, 2-hydroxy-4-n-octoxybenzophenone, 2-hydroxy-4-n-dodecyloxybenzophenone, 2-hydroxy-4-n-benzyloxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-propoxybenzophenone, 2,2′-dihydroxy-4-methoxy-4′-butoxybenzophenone, 2,3,4-trihydroxybenzophenone, 2-(2-hydroxy-5-t-methylphenyl)benzotriazole, 2-(2-hydroxy-5-t-octylphenyl)benzotriazole, 2-(2-hydroxy-3,5-di-t-butylphenyl)benzotriazole, ethyl-2-cyano-3,3-diphenyl acrylate, 2-ethylhexyl-2-cyano-3,3′-diphenyl acrylate, 2-(2-hydroxy-4-hexyloxylphenyl)-4,6-diphenyltriazine, (co)polymer of 2-hydroxy-4-(2-acryloxyethoxy)benzophenone, (co)polymer of 2-(2′-hydroxy-5′-methacryloxyethylphenyl)-2H-benzotriazole, reaction product of 2,4-dihydroxybenzophenone and γ-glycidoxypropyltrimethoxysilane, reaction product of 2,2′,4,4′-tetrahydroxybenzophenone and γ-glycidoxypropyltrimethoxysilane, and (partial) hydrolyzates thereof. They may be used alone or in combination with at least one another.

The organic ultraviolet-absorbing agent should be used in an amount of 0 to 100 parts by weight for the total amount (100 parts by weight) of the components (1), (2), and (3). If it is used, its amount should preferably be 0.3 to 50 parts by weight, particularly 0.3 to 30 parts by weight.

The organic ultraviolet light stabilizer should preferably be one which has at least one cyclic hindered amine structure in its molecule and which is highly miscible with the composition for hard coating according to the present invention and is only slightly volatile. Examples of the organic ultraviolet light stabilizer are listed below.
3-dodecyl-1-(2,2,6,6-tetramethyl-4-piperidinyl)pyrrolidine-2,5-dione,
N-methyl-3-dodecyl-1-(2,2,6,6-tetramethyl-4-piperidinyl)-pyrrolidine-2,5-dione,
N-acetyl-3-dodecyl-1-(2,2,6,6-tetramethyl-4-piperidinyl)-pyrrolidine-2,5-dione,
bis(2,2,6,6-tetramethyl-4-piperidyl) sebacate,
bis(1,2,2,6,6-pentamethyl-4-piperidyl) sebacate,
tetrakis(2,2,6,6-tetramethyl-4-piperidyl) 1,2,3,4-butane-tetracarboxylate,
tetrakis(1,2,2,6,6-pentamethyl-4-piperidyl) 1,2,3,4-butane-tetracarboxylate,
condensate of 1,2,3,4-butanetetracarboxylic acid,
2,2,6,6-tetramethyl-piperidinol, and tridecanol,
8-acetyl-3-dodecyl-7,7,9,9-tetramethyl-1,3,8-triazaspiro-[4,5]decane-2,4-dione,
condensate of 1,2,3,4-butanetetracarboxylic acid,
1,2,2,6,6-pentamethyl-4-piperidinol, and
β,β,β,β′-tetramethyl-3,9-(2,4,8,10-tetraoxaspiro[5,5]-undecane) diethanol, and
condensate of 1,2,3,4-butanetetracarboxylic acid,
1,2,2,6,6-pentamethyl-4-piperidinol, and
β,β,β,β′-tetramethyl-3,9-(2,4,8,10-tetraoxaspiro[5,5]-undecane) diethanol.
   The organic ultraviolet light stabilizer may be stabilized by combination with a silylated light stabilizer exemplified below, which is disclosed in JP-B S61-56187. 2,2,6,6-tetramethylpiperidino-4-propyltrimethoxysilane, 2,2,6,6-tetramethylpiperidino-4-propylmethyldimethoxysilane, 2,2,6,6-tetramethylpiperidino-4-propyltriethoxysilane, and 2,2,6,6-tetramethylpiperidino-4-propylmethyldiethoxysilane, and (partial) hydrolyzates thereof. These light stabilizers may be used alone or in combination with at least one another.

The organic ultraviolet light stabilizer should be used in an amount of 0 to 10 parts by weight for the total amount (100 parts by weight) of the components (1), (2), and (3). If it is used, its amount should preferably be 0.03 to 10 parts by weight, particularly 0.03 to 7.5 parts by weight.

The weather-resistant hard coating composition according to the present invention may be incorporated with such optional components as pH adjustor, leveling agent, dehydrant, thickener, pigment, dye, metal powder, antioxidant, heat reflecting/absorbing agent, flexibilizer, antistatic agent, antistaining agent, and water repellent, in an amount not harmful to the effect of the present invention.

The composition should have its pH adjusted in an adequate range, preferably from 2 to 7, more preferably from 3 to 6, so that it keeps good storage stability. With a pH value outside this range, it will be poor in storage stability. The pH will be adjusted in this range by adding a pH adjustor. A basic compound such as ammonia and ethylenediamine should be used for adjustment of pH values lower than the foregoing range, and an acidic compound such as hydrochloric acid, nitric acid, acetic acid, and citric acid should be used for adjustment of pH values higher than the foregoing range. No specific restrictions are imposed on the method for pH adjustment.

The composition may be applied to organic resin substrates by any ordinary method, such as brushing, spraying, dipping, flow coating, roll coating, curtain coating, spin coating, and knife coating.

The curing of the coating film formed from the composition for weather-resistant hard coating may be allowed to stand in the atmospheric air for air-drying or heat-drying. The temperature and duration of curing are not specifically restricted. An adequate curing temperature should be lower than the heat resisting temperature of the substrate, and an adequate curing time is ten minutes to two hours. To be more specific, curing should be accomplished at 80 to 135° C. for 30 minutes to two hours.

The resulting hard coating is not specifically restricted in film thickness. An adequate film thickness should be selected according to application. A preferable thickness is 0.1 to 50 μm, particularly 3 to 25 μm for the coating film to have satisfactory hardness, good scratch resistance, extended stable adhesion, and extended weather resistance.

The composition may be incorporated with a fluorine surfactant or silicone surfactant, such as “Fluorad FC-4430” (from Sumitomo 3M Limited) and “KP-341” (from Shin-Etsu Chemical Co., Ltd.), in an adequate amount for the resulting coating film to have a smooth surface. Moreover, it may also be incorporated with a curing catalyst for crosslinking, such as “Neostan U-810” (from Nitto Kasei Co., Ltd.), “B-7” (from Nippon Soda Co., Ltd.), and “Orgatix ZA-60, TC-200” (from Matsumoto Pharmaceutical Manufacture Co., Ltd.) in a catalytic amount to accelerate the curing of the coating film.

Upon application onto a substrate, the composition cures on the substrate to form a hard coating film which provides extended weather resistance owing to the effect produced by the organic ultraviolet-absorbing group contained in the component (2) constituting the hard coating layer.

### Organic Resin Substrate

The composition should preferably be applied to the surface of the organic resin substrate or the plastics material formed from any one of polycarbonate, polystyrene, acrylic resin, modified acrylic resin, urethane resin, thiourethane resin, polycondensate of halogenated bisphenol-A and ethylene glycol, acrylurethane resin, acrylic resin containing halogenated aryl groups, and sulfur-containing resin. The resin substrate may be one having a surface which has undergone chemical treatment, corona discharge treatment, plasma treatment, acid or alkali treatment, or coating with a material different from the substrate. Examples of the coated resin substrate include a laminate sheet composed of a base of polycarbonate resin and a surface layer of acrylic resin or urethane resin, or a laminate sheet composed of a base of polyester resin and a surface layer of acrylic resin. Such a laminate sheet may be formed by coextrusion or lamination coating.

Thus, the present invention provides a coated article which composed of an organic resin substrate, especially a molded substrate of polycarbonate resin, which has a cured coating film of the composition for weather-resistant hard coating as defined above formed directly on at least one surface the substrate, the coated article having the property that it passes the initial adhesion test and the adhesion test after dipping in boiling water in a ratio of at least 97% and it gives a ΔHz (delta haze) value less than 15% in the Taber abrasion test.

Here, the initial adhesion test and the adhesion test after dipping in boiling water are carried out in accordance with ASTM D870. This test method consists of making crosscuts (11 cuts each in the horizontal and vertical directions at intervals of 1 mm for division into 100 small squares) in the coating film with a razor blade, and firmly putting a piece of adhesive tape “Cellotape” (trademark) (from Nichiban K.K.) on the squares and abruptly peeling off the adhesive tape in the direction at 90°. The test result is expressed in terms of the area (%) of the coating film which remains without being peeled off.

The Taber abrasion test is carried out in accordance with ASTM D1044. This test method consists of subjecting a specimen to abrasion by the abrading ring CS-10F attached to the Taber abrading machine, which turns 500 times under a load of 500 g, and then measuring the haze of the specimen. The test result is expressed in terms of ΔHz (delta haze) % which is the difference in haze measured before and after abrasion.

### EXAMPLES

The invention will be described in more detail with reference to the following Synthesis Examples, Examples, and Comparative Examples, which are not intended to restrict the scope thereof. In the following Examples, “%” means “% by weight” and “parts” means “parts by weight.” The viscosity is expressed in terms of values measured at 25° C. in accordance with JIS Z8803. The weight average molecular weight is expressed in terms of standard polystyrene determined by gel permeation chromatography (GPC).

### [Synthesis of Silicone Resin as the Component (1)]

### Synthesis Example 1

In a 2-liter flask were placed 272 g (2.0 Si mol) of methyltrimethoxysilane and 15 g (0.1 Si mol) of tetramethylsilane. After cooling to about 10° C., the flask was given dropwise 211 g of “Snowtex 0” (aqueous dispersion of silica sol containing 20% SiO₂ with an average particle diameter of 15 to 20 nm, made by Nissan Kagaku Kogyo K.K.) and 93 g of aqueous solution of 0.25N acetic acid for hydrolysis, with the contents of the flask cooled below 40° C. This step was followed by stirring at a temperature of up to 40° C. for one hour and then at 60° C. for three hours to complete hydrolysis.

Subsequently, the flask was given 300 g of cyclohexane and the reaction product was freed of methanol (resulting from hydrolysis) by distillation under normal pressure, with the liquid heated up to 92° C. The resulting condensate was diluted with 400 g of isopropanol, and the resulting solution was mixed by stirring with 1.6 g of acetic acid and 1.6 of 25% aqueous solution of tetramethylammonium hydroxide (TMAH). After filtration through a filter paper, there was obtained a colorless clear silicone resin solution containing 19.2% of non-volatile matter and having a weight average molecular weight of 2,510 with a dispersity of 1.84 determined by GPC.

The thus obtained silicone resin solution was incorporated with 0.1 g of polyether-modified silicone “KP-341” (made by Shin-Etsu Chemical Co., Ltd.) as a leveling agent to impart a smooth surface to the coating film. After stirring, there was obtained a silicone resin solution as the component (1-a).

### Synthesis Example 2

In a 1-liter flask were placed 65 g (0.48 Si mol) of 1,2-styrenebis(trimethoxysilane), 300 g of “IPA-ST” (silica sol dispersed in isopropanol, containing 30% SiO₂ with an average particle diameter of 15 to 20 nm, made by Nissan Chemical Industries, Ltd.), 100 g of isopropanol, and 2 g of “Lewatit K2649DR” (cation exchange resin, made by Lanxess K.K.). The flask was given 40 g of pure water at room temperature, followed by stirring at 40° C. for three hours to complete hydrolysis and condensation. After cooling to room temperature, the reaction product was incorporated with 170 g of acetylacetone, 6 g of aluminum acetylacetonate, and 0.1 g of polyether-modified silicone “KP-341” (made by Shin-Etsu Kagaku Kogyo K.K.) as a leveling agent. After stirring, there was obtained a silicone resin solution, containing 20.2% of non-volatile matter, having a weight average molecular weight of 1,830 with a dispersity of 1.72 determined by GPC. This solution is designated as the component (1-b).

### Synthesis Example 3

The same procedure as in Synthesis Example 2 was repeated except that the 1,2-ethylenebis(trimethoxysilane) was replaced by 40 g (0.12 Si mol) of hydroxybenzophenoneoxypropyltrimethoxysilane and 19.6 g (0.12 Si mol) of 1,6-hexylenebis(trimethoxysilane). The reaction product was diluted with isopropanol so that the resulting solution contains non-volatile matter in a concentration of 20%. Thus, there was obtained a silicone resin solution, containing 19.4% of non-volatile matter, having a weight average molecular weight of 2,050 with a dispersity of 1.82 determined by GPC. This solution is designated as the component (1-c).

### Synthesis Example 4

The same procedure as in Synthesis Example 2 was repeated except that the 1,2-ethylenebis(trimethoxysilane) was replaced by 49.5 g (0.24 Si mol) of “X-12-965” (tris(3-trimethoxysilylpropyl)isocyanurate, made by Shin-Etsu Chemical Co., Ltd.). The reaction product was diluted with isopropanol so that the resulting solution contains non-volatile matter in a concentration of 20%. Thus, there was obtained a silicone resin solution, containing 18.9% of non-volatile matter, having a weight average molecular weight of 1,830 with a dispersity of 2.05 determined by GPC. This solution is designated as the component (1-d).

### [Synthesis of Vinyl Copolymer, as Component (2), Having Organic Ultraviolet-Absorbing Groups and Reactive Groups in the Side Chain]

### Synthesis Example 5

In a 2-liter flask equipped with a stirrer, condenser, and thermometer was placed 167 g of diacetone alcohol as a solvent. The solvent was heated at 80° C. under a nitrogen stream. To the flask was added a portion (390 g) of a previously prepared solution of monomer mixture composed of 81.0 g of (2-[2′-hydroxy-5′-(2-methacryloxyethyl)phenyl]-2H-benzotriazole (“RUVA-93” made by Otsuka Chemical Co., Ltd), 67.5 g of 2-hydroxyethyl methacrylate, 301.5 g of methyl methacrylate, and 355 g of diacetone alcohol. Sequentially, to the flask was further added a portion (80 g) of a previously prepared solution containing 2.3 g of 2,2′-azobis(2-methylbutyronitrile) as a polymerization initiator dissolved in 177.7 g of diacetone alcohol. The reactants underwent reaction at 80° C. for 30 minutes. To the flask were further added dropwise the remainders of the solutions of monomer mixture and polymerization initiator simultaneously at 80 to 90° C. over 1.5 hours. The reaction product was stirred further at 80 to 90° C. for five hours. Thus there was obtained a vinyl copolymer having organic ultraviolet-absorbing groups and reactive groups in the side chain. This product is designated as the component (2-a).

The thus obtained vinyl copolymer as the component (2-a) was found to contain 40.3% of non-volatile matter, 15% of hydroxyl group-containing vinyl monomer, and 18% of ultraviolet-absorbing monomer and to have a viscosity of 8,180 mPa·s, and a weight average molecular weight of 62,300 determined by GPC.

### Synthesis Examples 6 to 9

The same procedure as Synthesis Example 4 was repeated to obtain the vinyl copolymers having organic ultraviolet-absorbing groups and reactive groups in the side chain, which are designated as the components (2-b) to (2-e), respectively, except that the kind and amount of the monomer was replaced by those which are shown in Table 1.

### [Inorganic Oxide Fine Particles as the Component (6)]

The component (6) includes the component (6-a) and the component (6-b) which are defined as follows.
(6-a) “PMA-ST” made by Nissan Chemical Industries, Ltd., a dispersion of silica sol in propyleneglycol methyl ether acetate, containing 30% of solids.
(6-b) “RTTDNB 15 wt %-E88” made by C.I. Kasei Co., Ltd., a dispersion (with 15% solids in mixed alcohol containing a dispersant) of titanium oxide fine particles (produced by DC arc plasma method and subsequently coated with silica) having an average particle diameter (volume mean diameter D₅₀) of 99 nm.

### [Preparation of the Composition for Weather-Resistant Hard Coating]

### Example 1

A mixture was prepared by thoroughly mixing 35 g of the vinyl copolymer as the component (2-a) obtained in Synthesis Example 5 and 15 g of propyleneglycol methyl ether. To this mixture was added 30 g of the silicone resin solution as the component (1-a) obtained in Synthesis Example 1. After thorough mixing, the resulting mixture was filtered through a nylon mesh strainer (#100). Thus there was obtained the composition for weather-resistant hard coating which is designated as the component (a).

### Examples 2 to 5 and Comparative Examples 1 to 3

The same procedure as in Example 1 was repeated except that the kind and amount of the vinyl copolymer and silicone resin solution were changed and an optional additive was added as shown in Table 2. Thus there were obtained the compositions for weather-resistant hard coating, which are designated as the components (b) to (e) and the comparative components (f) to (h).

### [Preparation and Evaluation of Coated Articles]

### Examples 6 to 10

Each sample of the compositions for weather-resistant hard coating as the components (a) to (e) obtained in Examples 1 to 5 was applied to a surface-cleaned Lexan polycarbonate sheet (150 mm×150 mm×5 mm thick) by flow coating to form a coating film which would become a hard coating about 9 to 14 μm thick after curing. The coating film was heated for curing at 120° C. for 60 minutes. Thus there was obtained an article with hard coating. This article was examined for its properties in the following manner. The results are shown in Table 3.

### Comparative Examples 4 to 6

Samples of coated articles were prepared in the same way as in Examples 6 to 10 from the compositions for weather-resistant hard coating obtained in Comparative Examples 1 to 3. The thus obtained samples were examined for their properties in the following manner. The results are shown in Table 4.

### [Method for Evaluation of Cured Coating Film]

### Clarity Hz

The sample of coated article was examined for clarity (or haze) by using a haze meter (“NDH2000” made by Nippon Denshoku Industries Co., Ltd.).

### Scratch Resistance ΔHz

The sample of coated article was examined for scratch resistance in terms of difference in haze (ΔHz) measured before and after abrasion test. The abrasion test was carried out in accordance with ASTM D1044 by using a Taber abrasion tester equipped with an abrading ring CS-10F which turns 500 times under a load of 500 g.

### Initial Adhesion

The sample of coated article was examined for initial adhesion by cross-cut adhesion test in accordance with ASTM D870. This test method consists of making crosscuts (11 cuts each in the horizontal and vertical directions at intervals of 1 mm for division into 100 small squares) in the coating film with a razor blade, and firmly putting a piece of adhesive tape (“Cellotape” from Nichiban Co., Ltd.) on the squares and abruptly peeling off the adhesive tape in the direction at 90°. The test result is expressed in terms of the area (%) of the coating film which remains without being peeled off.

Adhesion after Dipping in Water

The sample of coated article was examined for adhesion after dipping in ion-exchanged water at 65° C. for three days in the same way as used for the test of initial adhesion.

Adhesion after Dipping in Boiling Water

The sample of coated article was examined for adhesion after dipping in boiling ion-exchanged water for six hours in the same way as used for the test of initial adhesion.

### Weather Resistance

The sample of coated article was examined for weather resistance by artificial weathering in “Eye Super UV tester W-151” made by Iwasaki Electric Co., Ltd. In this test, the sample was subjected to light at an illuminance of 50 mW/cm² and water spray (for ten seconds every hour) for five hours at a black panel temperature of 63° C. and a humidity of 50% RH and then for one hour at a black panel temperature of 30° C. and a humidity of 95% RH. The cycle for exposure to light and water spray was repeated 40 times and 70 times.

Before and after this weathering test, the sample was examined for change in yellowing (AYI) in accordance with JIS K7103.

After this weathering test, the sample was also examined visually or microscopically (with a magnification of 250×) for cracking and peeling and rated according to the following criteria.

### Cracking

After the weathering test, the appearance of the coating film was graded as follows.

Good: No cracking

Fair: Slight cracking

Poor: Overall cracking

### Peeling

After the weathering test, the state of the coating film was graded as follows.

Good: No peeling

Fair: Partial peeling

Poor: Overall peeling

TABLE 1
Composition of the vinyl copolymer (as component (2))
having organic ultraviolet-absorbing groups and
reactive groups in the side chain
Unit: Parts (wt % of solid matter)

| | | Synthesis Example | | | | | |
|---|---|---|---|---|---|---|---|
| | | 4 | 5 | 6 | 7 | 8 | 9 |
| Vinyl copolymer (2) | | 2-a | 2-b | 2-c | 2-d | 2-e | 2-f |
| Vinyl monomer | RUVA-1 | 81.0 | 103.5 | 103.5 | | | 81.0 |
| containing | | (18%) | (23%) | (23%) | | | (18%) |
| ultraviolet- | RUVA-2 | | | 22.5 | | | |
| absorbing group | | | | (5%) | | | |
| (2-1) | | | | | | | |
| Vinyl monomer | HEMA | 67.5 | | 22.5 | | 67.5 | |
| containing | | (15%) | | (5%) | | (15%) | |
| reactive group | MPTMS | | 67.5 | | | | |
| (2-2) | | | (15%) | | | | |
| | GMA | | | 22.5 | | | |
| | | | | (5%) | | | |
| Other monomer | MMA | 301.5 | 274.5 | 234.0 | 450.0 | 301.5 | 184.5 |
| (2-3) | | (67%) | (61%) | (52%) | (100%) | (67%) | (41%) |
| | EMA | | | 45.0 | | 81.0 | 184.5 |
| | | | | (10%) | | (18%) | (41%) |
| | MHALS | | 4.5 | | | | |
| | | | (1%) | | | | |

| | | | | | | |
|---|---|---|---|---|---|---|
| Total amount charged | 450 | 450 | 450 | 450 | 450 | 450 |
| Non-volatile matter (%) | 40.3 | 41.2 | 39.2 | 41.0 | 40.8 | 42.0 |
| Viscosity (mPa · s) | 8180 | 7950 | 7280 | 6630 | 5860 | 8040 |
| GPC (Mw) | 62,900 | 53,400 | 50,900 | 68,400 | 50,400 | 57,700 |

(Remarks)
RUVA-1: 2-[2′-hydroxy-5′-(2-methacryloxyethyl)phenyl]-2H-benzotriazole (RUVA-93, made by Otsuka Chemical Co., Ltd.)
RUVA-2: 2-hydroxy-4-(2-acryloxyethyl)benzophenone (BP-1A, made by Osaka Organic Chemical Industry Ltd.)
HEMA: 2-ethylhydroxy methacrylate
MPTMS: γ-methacryloxypropyltrimethoxysilane
GMA: Glycidyl methacrylate
MMA: Methyl methacrylate
EMA: Ethyl methacrylate
MHALS: 1,2,2,6,6-pentamethyl-4-piperidyl methacrylate

TABLE 2
Formulation of composition for weather-resistant hard coating
Unit: Parts (wt % of solid matter)

| | | | | | | | Comparative | | |
|---|---|---|---|---|---|---|---|---|---|
| | | Example | | | | | Example | | |
| | | 1 | 2 | 3 | 4 | 5 | 1 | 2 | 3 |
| Composition for weather- | | a | b | c | d | e | f | g | h |
| resistant hard coating | | | | | | | | | |
| Silicone resin solution (1) | | 1-a | 1-c | 1-b | 1-b | 1-d | 1-a | 1-b | 1-b |
| (containing curing catalyst (3)) | | 45 | 30 | 25 | 30 | 40 | 30 | 30 | 30 |
| | | (45%) | (30%) | (25%) | (30%) | (40%) | (30%) | (30%) | (30%) |
| Details of | Silicone resin | 35.1 | 9.9 | 7.5 | 9.0 | 16.8 | 23.8 | 9.0 | 9.0 |
| solids in | (%) | | | | | | | | |
| silicone | Inorganic fine | 9.0 | 18.9 | 16.5 | 19.8 | 21.6 | 6.1 | 17.8 | 19.8 |
| resin solution | particles (%) | | | | | | | | |
| | silica | | | | | | | | |
| | Curing catalyst | 0.9 | 1.2 | 1.0 | 1.2 | 1.6 | 0.1 | 1.2 | 1.2 |

| | | | | | | | | |
|---|---|---|---|---|---|---|---|---|
| Vinyl copolymer (2) | 2-a | 2-b | 2-c | 2-b | 2-b | 2-d | 2-e | 2-f |
| | 27.5 | 35 | 37.5 | 35 | 30 | 35 | 35 | 35 |
| | (55%) | (70%) | (75%) | (70%) | (60%) | (70%) | (70%) | (70%) |
| Solvent (4) | PGM | DAA | PGM | PGM | DAA | PGM | PGM | PGM |
| | 8.7 | 15 | 18.7 | 12.3 | 11.2 | 15 | 30 | 15 |
| Water (5) | | 0.1 | | | | | | |
| Inorganic fine particles (6) | | | 6-a | 6-b | | | | |
| | | | 6.7 | 6.7 | | | | |
| UV absorber other than (2-1) | T400 | | | | T400 | | T400 5 | |
| | 0.4 | | | | 0.4 | | | |

(Remarks)
PGM: Propyleneglycol methyl ether
DAA: Diacetone alcohol
T400: Triazine UV absorber (“Tinuvin 400” made by Ciba Specialty Chemicals Inc.)

TABLE 3
Results of evaluation of articles
with weather-resistant hard coating

| | | Example | | | | |
|---|---|---|---|---|---|---|
| Structure of coating film | | 6 | 7 | 8 | 9 | 10 |
| Composition for | | a | b | c | d | e |
| weather-resistant hard coating | | | | | | |
| Result of evaluation | | | | | | |
| Clarity Hz (%) | | 0.24 | 0.18 | 0.33 | 0.69 | 0.54 |
| Scratch resistance ΔHz (%) | | 13 | 9 | 5 | 7 | 6 |
| Initial adhesion (%) | | 100 | 98 | 100 | 99 | 100 |
| Adhesion after dipping in | | 99 | 89 | 100 | 100 | 99 |
| water at 65° C. for 3 days (%) | | | | | | |
| Adhesion after dipping in | | 98 | 90 | 99 | 100 | 98 |
| boiling water for 6 hours (%) | | | | | | |
| Weathering | Yellowing ΔYI | 0.81 | 0.63 | 0.39 | 0.49 | 0.52 |
| test | Cracking | good | good | good | good | good |
| 40 cycles | Peeling | good | good | good | good | good |
| Weathering | Yellowing ΔYI | 1.82 | 1.29 | 0.89 | 0.95 | 1.06 |
| test | Cracking | good | good | good | good | good |
| 70 cycles | Peeling | good | good | good | good | good |

TABLE 4
Results of evaluation of articles with weather-resistant hard coating

| | Comparative Example | | |
|---|---|---|---|
| Structure of coating film | 4 | 5 | 6 |
| Composition for weather-resistant | f | g | h |
| hard coating | | | |

Result of evaluation

| Clarity Hz(%) | | 3.42 | 0.21 | 1.94 |
|---|---|---|---|---|
| Scratch resistance ΔHz (%) | | 25 | 8 | 16 |
| Initial adhesion (%) | | 100 | 100 | 100 |
| Adhesion after dipping in water at | | 75 | 98 | 99 |
| 65° C. for 3 days (%) | | | | |
| Adhesion after dipping in boiling | | 82 | 99 | 99 |
| water for 6 hours (%) | | | | |
| Weathering | Yellowing ΔYI | 12.8 | 15.3 | 0.92 |
| test 40 cycles | Cracking | good | good | good |
| | Peeling | poor | poor | good |
| Weathering | Yellowing ΔYI | — | — | 3.58 |
| test 70 cycles | Cracking | — | — | good |
| | Peeling | — | — | poor |

Japanese Patent Application No. 2011-085068 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A weather-resistant hard coating composition to be used for direct coating on at least one surface of an organic resin substrate, said composition comprising the following components:
(1) a silicone resin resulting from (co)hydrolysis and condensation of at least one selected from those alkoxysilanes represented by the following formulas (1-1), (1-2), and (1-3) or condensates of their partial hydrolyzates,
(R¹)ₘ(R²)ₙSi(OR³)₄₋ₘ₋ₙ (1-1)
wherein R¹ and R² are independently a hydrogen atom or an unsubstituted or substituted monovalent hydrocarbon group, in which the substituent groups may be connected each other, R³ is an alkyl group having 1 to 3 carbon atoms, and m and n are independently 0 or 1, with m+n being 0, 1, or 2,
(R⁴O)₃₋ₚ(R⁶)ₚSi—R⁸—Si(R⁷)_{q}(OR⁵)_{3-q} (1-2)
wherein R⁴ and R⁵ are independently an alkyl group having 1 to 3 carbon atoms, R⁶ and R⁷ are independently a hydrogen atom or an unsubstituted or substituted monovalent hydrocarbon group, R⁸ is an oxygen atom, phenylene group, or an unsubstituted or substituted alkylene group having 2 to 10 carbon atoms, and p and q are independently 0 or 1,
X—[(R¹⁵)Si(R¹⁶)_{y}(OR¹⁷)_{3-y}]_{z} (1-3)
wherein X is a 1,3,5-trimethylcyclotrisiloxane residue, 1,3,5,7-tetramethylcyclotetrasiloxane residue, or isocyanurate residue, R¹⁵ is an alkylene group having 1 to 3 carbon atoms, R¹⁶ is a hydrogen atom or an unsubstituted or substituted monovalent hydrocarbon group, R¹⁷ is an alkyl group having 1 to 3 carbon atoms, y is 0 or 1, and z is 3 or 4;
(2) a vinyl copolymer having in its side chain an organic ultraviolet-absorbing group and a reactive group selected from an alkoxysilyl group, hydroxyl group, epoxy group, carboxylic acid group, and amino group;
(3) a curing catalyst; and
(4) a solvent;
wherein the silicone resin as component (1) and the vinyl copolymer as component (2) are present in such amounts in terms of solids that the ratio of (1)/(2) is from 10/90 to 50/50 by weight.

2. The composition as defined in claim 1, wherein the silicone resin as component (1) is formed from the alkoxysilanes represented by the formulas (1-1), (1-2), and (1-3) such that the ratio of (1-1)/[(1-2)+(1-3)] is from 50/50 to 0/100 in terms of mol % of silicon.

3. The composition as defined in claim 1, wherein the formula (1-1) is specified such that R¹ is a methyl group or a monovalent hydrocarbon group substituted with an ultraviolet-absorbing group, m=1, n=0, and R³ is a methyl group; the formula (1-2) is specified such that R⁸ is an unsubstituted or substituted alkylene group having 2 to 8 carbon atoms, p and q each are 0, R⁴ and R⁵ each are a methyl group; and the formula (1-3) is specified such that X is an isocyanurate residue, y=0, R¹⁷ is a methyl group, and z=3.

4. The composition as defined in claim 1, wherein the silicone resin as component (1) is obtained by hydrolysis and condensation from at least one selected from the group consisting of the alkoxysilanes represented by the formulas (1-2) and (1-3) and the condensates of partial hydrolyzates thereof.

5. The composition as defined in claim 1, wherein the silicone resin as component (1) is obtained by hydrolysis and condensation of at least one selected from the group consisting of the alkoxysilanes represented by the formula (1-3) and the condensates of partial hydrolyzes thereof.

6. The composition as defined in claim 1, wherein the component (2) is a copolymer obtained by copolymerization from the following monomer components (2-1) to (2-3):
(2-1) a vinyl monomer having an organic ultraviolet-absorbing group: 5 to 50% by weight;
(2-2) a reactive group-containing vinyl monomer which contains at least one selected from the group consisting of alkoxysilyl group, hydroxyl group, and epoxy group: 2 to 30% by weight; and
(2-3) other monomer copolymerizable with said monomers: 20 to 93% by weight.

7. The composition as defined in claim 6, wherein the component (2-2) is a hydroxyl group-containing vinyl monomer.

8. The composition as defined in claim 1, which further comprises water as component (5).

9. The composition as defined in claim 1, which further comprises inorganic oxide fine particles as component (6).

10. The composition as defined in claim 9, wherein the component (6) is at least one selected from the group consisting of silica, zinc oxide, titanium oxide, and cerium oxide.

11. The composition as defined in claim 1, which further comprises any organic ultraviolet-absorbing agent and/or organic ultraviolet light stabilizer other than the component (2).

12. A coated article comprising an organic resin substrate and a hard coating film formed directly on at least one surface thereof from the weather-resistant hard coating composition as defined in claim 1, said coated article having the property that it passes the adhesion test in a ratio of at least 97% and it gives a ΔHz (delta haze) value less than 15% in the Taber abrasion test.

13. The coated article as defined in claim 12, in which the organic resin substrate is a molded one formed from polycarbonate resin.
